(19) United States
(12) Patent Application Publication
(10) Pub. No.: US 2020/0406401 A1
(43) Pub. Date: Dec. 31, 2020

(54) METHOD FOR PRODUCING BATTERY ELECTRODES

(71) Applicant: VOLKSWAGEN AKTIENGESELLSCHAFT, Wolfsburg (DE)

(72) Inventors: Alexander BREUER, Celle (DE); Dennis BÖHM, Wolfenbüttel (DE); Marco JORDAN, Salzgitter (DE)

(73) Assignee: VOLKSWAGEN AKTIENGESELLSCHAFT, Wolfsburg (DE)

(21) Appl. No.: 16/912,323

(22) Filed: Jun. 25, 2020

(30) Foreign Application Priority Data
Jun. 25, 2019 (DE) 10 2019 209 183.0

(51) Int. Cl. B23K 26/38; H01M 4/75; H01M 4/139; H01M 4/04

(52) U.S. Cl. CPC B23K 26/38; H01M 4/75; B23K 2101/16; H01M 4/0404; H01M 4/139

(57) ABSTRACT

A method for producing battery electrodes, in which an electrode strip material comprising a foil and comprising an active material coating applied thereto is separated at predetermined cutting points to form a number of battery electrodes, wherein the electrode strip material is conveyed on a planar vacuum belt in a conveying direction to a cutting gap, wherein, in a first method step, the active material coating of a cutting point is partially ablated using a first laser beam before the cutting point reaches the cutting gap, and wherein, in a second method step, the active material coating and the foil of the cutting point are completely severed using a second laser beam when the cutting point is in the region of the cutting gap.

### CROSS REFERENCE TO RELATED APPLICATION

This application claims priority from German Patent Application No. 10 2019 209 183.0, filed Jun. 25, 2019, which is incorporated herein by reference in its entirety.

### FIELD OF THE INVENTION

The invention relates to a method for producing battery electrodes, in which an electrode strip material comprising a foil and comprising an active material coating applied thereto is separated at predetermined cutting points to form a number of battery electrodes. The invention further relates to a device for carrying out the method and to a vehicle battery comprising a battery electrode produced using the method.

### BACKGROUND OF THE INVENTION

Electrically drivable or driven motor vehicles, such as electric or hybrid vehicles, typically have an electric motor as the drive machine, which motor is coupled to an in-vehicle electrical (high-voltage) energy store for the supply of electrical energy. Such energy stores are designed in the form of (vehicle) batteries, for example.

An electrochemical battery is to be understood here in particular as a secondary battery of the motor vehicle, in which consumed chemical energy can be restored by means of an electrical (re)charging process. Such batteries are designed in particular as rechargeable electrochemical batteries, for example as rechargeable lithium-ion batteries. In order to generate or provide a sufficiently high operating voltage, such batteries typically have a plurality of individual battery cells which are connected in a modular manner.

Batteries of the type mentioned have, at a battery cell level, a cathode and an anode as well as a separator and an electrolyte. The electrodes, i.e. the anode and the cathode, are made from a particular (electrode) active material.

In order to produce batteries, extrusion processes are possible, for example, in which the battery electrodes of the battery cells are produced from a plastic mass. In this case, the electrode pastes are applied as an active material coating to a particular current conductor, in particular to a copper or aluminum foil. As a result, a strip-like or strip-shaped electrode strip material or electrode substrate is produced, which is assembled and further processed in particular as an endless material or roll material, as what is known as an electrode coil. The endless electrode strip material has a length that is dimensioned so as to be substantially larger than its width or thickness or height.

A number of battery electrodes are then produced from the electrode strip material. For this purpose, the electrode strip material is separated, i.e. split or cut into lengths, at predetermined cutting points. The cutting points extend in particular along the width of the electrode strip material. This means that the cutting points are directed substantially obliquely or transversely to the longitudinal direction of the endless electrode strip material.

The battery electrodes are separated mechanically, for example, in particular by means of a stamping process, or by means of a laser beam.

In the case of mechanical separation, it is possible, for example, for the battery electrodes to be separated from the electrode strip material with a full cut, or for the battery electrodes to be separated in a two-part separation process, involving notching an upper and lower edge of the cutting point followed by a transverse cut for complete severance.

In the case of laser separation, a laser beam is guided over the cutting point, for example using a (galvo) scanner. The laser beam ablates the active material coating and the foil. “Ablating” or “ablation” is to be understood here in particular as laser ablation, in which a laser beam locally heats a material in such a way that a plasma is formed and the material is removed by the heating. The laser beam is focused on the electrode strip material, and the material is removed in a heat input zone or a heat influence zone, and the cutting point is thus severed.

The electrode strip material is guided in the longitudinal direction thereof to a processing or cutting region, for example by means of a conveyor, in order to be separated. The conveyor is then stopped so that the electrode strip material is separated mechanically or by means of a laser at the particular cutting point when the conveyor is at a standstill. The conveyor is then started again, and the separated battery electrode is thus moved away from the cutting region, and a new cutting point of the electrode strip material is moved toward the cutting region.

The foil or the current conductor of the electrode strip material is relatively thin and has a foil thickness of only approximately 6 to 12 μm (micrometers), for example. Due to the regular or periodic, i.e. cyclic, stopping and starting of the conveyor in the course of the separation, acceleration forces act on the electrode strip material, which can lead to the foil and/or the active material becoming damaged. In order, however, to reduce the cycle time and demonstrate an economical production process, it is necessary to reduce the acceleration and deceleration speeds of the conveyor, which has a detrimental effect on the time taken to produce the battery electrodes.

In the case of laser separation, the conveyor must be at a standstill since typical scanners for moving the laser beam along the cutting point have relatively low laser feed speeds in the region of 6 m/s (meters per second) with a mirror diameter of 50 mm (millimeters). Due to the slow laser feed speeds of known scanners, the conveyor has to be stopped during separation in order to achieve a high cutting edge quality and so as not to damage or destroy the conveyor. The cutting region is usually designed as a cutting or cut gap with bilateral suction for the ablated material.

In order to realize more powerful batteries or battery cells, battery electrodes having relatively large dimensions are desired in particular. A separation of electrode strip materials having an increasingly larger width, and thus longer cutting points, is therefore necessary. As a result, it is necessary for the scanner to cover a larger processing region in the case of laser separation. This requires a larger spot diameter or focus region of the laser beam, and thus a correspondingly larger heat input zone, as a result of which more energy is input into the active material coating. However, this disadvantageously reduces the cutting edge quality of the battery electrode.

Furthermore, in particular in the case of “on-the-fly” cuts, a larger cutting gap, in particular a larger clear width of the cutting gap, for example up to 100 mm, is therefore required, which results in the problem of deflection of the electrode strip material or the cutting point in the region of the cutting gap. Due to the deflection, the active material coating and the foil are no longer in the focus region of the laser beam, which further reduces the cutting edge quality of the separated battery electrodes. In addition, such a deflection places a high mechanical strain on the electrode strip material, which can result in damage or destruction of the electrode strip material.

DE 10 2017 216 133 A1 and WO 2018/228770 A1 each disclose a method for separating a strip-shaped electrode material on a curved surface. The curved surface is part of a wheel or a drum, which is divided into individual circumferential segments in the circumferential direction, with a cutting or cut gap being formed between every two circumferential segments. The wheel is a conveyor for the electrode material, with the circumferential segments holding or securing the guided electrode strip material by means of a vacuum or blowing air. A laser for separating or splitting the portion of the electrode material secured to the circumferential segment is provided on the circumferential surface of the wheel.

Due to the transverse or right-angled laser cut to be carried out on the moving, curved surface, it is necessary to reposition the laser or the focal point of the laser beam in the X-, Y- and Z-direction, for example by means of a combination of polygon or galvo scanners. In particular when producing larger-sized battery electrodes, the known methods cannot currently be implemented or realized since the laser beam cannot be adjusted quickly enough in the Z-direction by means of a galvo scanner while the wheel or drum is rotating.

The problem addressed by the invention is that of providing a particularly suitable method for producing battery electrodes. In particular, there should be a production flow which is as uniform as possible, in which the mechanical and thermal strain on the electrode strip material is reduced, and the highest possible cutting edge quality of the battery electrodes is ensured. The problem addressed by the invention is also that of providing a particularly suitable device for carrying out such a method and a particularly suitable vehicle battery comprising a battery electrode produced using such a method.

### SUMMARY OF THE INVENTION

According to the invention, the problem is solved in respect of the method with the features of an independent claim, in respect of the device with the features of an independent claim and in respect of the vehicle battery with the features of an independent claim. The dependent claims relate to advantageous embodiments and developments. The advantages and embodiments mentioned in respect of the method can also be transferred analogously to the device and/or the vehicle battery and vice versa.

The method according to the invention is suitable and designed for producing battery electrodes, in particular for vehicle batteries. According to the method, a strip-shaped or strip-like electrode strip material, in particular in the form of a roll material (electrode coil), comprising an electrically conductive foil as a current conductor and comprising an active material coating applied thereto, is separated, i.e. split or cut into lengths, at predetermined cutting points to form a number of battery electrodes.

According to the method, the electrode strip material is conveyed on a planar or flat, i.e. not curved, vacuum belt as a conveyor or transfer means in a conveying direction to a cutting gap that is fixed in position. This means that the electrode strip material is conveyed by the vacuum belt as web material to the cutting gap. The conveyance is planar, i.e. substantially in a horizontal plane. The vacuum belt suitably generates negative pressure, by means of which the electrode strip material, in particular in the region of the active material coating, is secured or held during the conveyance. The cutting gap is spatially fixed, which means that the cutting gap does not travel or move when the electrode strip material is being conveyed, but is in a fixed position with respect to the vacuum belt.

In a first method step, the active material coating of a cutting point is partially ablated using a first laser beam before the cutting point reaches the cutting gap. In a subsequent, second method step, the active material coating and the foil of the cutting point are completely severed using a second laser beam when the cutting point is in the region of the cutting gap. This results in a particularly suitable method for producing battery electrodes.

This means that the first laser beam creates a kerf or cutting notch in the active material coating in the region of the provided cutting point. Preferably, approximately 40% to 99% of the active material coating is ablated during the first method step. As a result, the electrode strip material is separated or severed easily and quickly in the subsequent, second method step when the cutting point is above the cutting gap. The laser separation is thus carried out in two successive steps according to the method. First, the deepest possible notch or kerf is made in the active material coating, and the electrode strip material is then completely severed or cut for separation or for a transverse cut. The electrode strip material can cool between the method steps, meaning the thermal load in the region of the cutting points is relatively low. As a result, this is advantageously transferred to the cutting edge quality of the battery electrodes.

Due to the planar vacuum belt, repositioning of the laser beam or the focal point of the laser beam in a Z-direction, i.e. perpendicular to the surface of the electrode strip material, is substantially not required or at least substantially reduced. This allows an increased cycle time in the production of the battery electrodes, which allows a uniform production flow.

For the first method step, no cutting or cut gap is necessary to interrupt the vacuum belt since the electrode strip material is not completely severed, but is only partially ablated. The first laser beam thus cannot hit the vacuum belt and damage or destroy it.

The cutting points extend in particular obliquely, i.e. transversely or perpendicularly, to the longitudinal direction of the electrode strip material. The electrode strip material has, for example, a width of more than 100 mm, in particular between 300 and 600 mm. This means that the separated battery electrodes in particular have an edge dimension of more than 100 mm, preferably between 300 to 600 mm.

For example, the electrode strip material has, in the longitudinal direction thereof, a non-coated or uncoated edge region of the foil, i.e. an edge-side foil region which is not provided with the active material coating, from which, in the course of the production of the battery electrodes, an associated conductor tab for contacting the battery electrode is produced in each case.

In an advantageous development, the first laser beam and/or the second laser beam are moved along the cutting point by means of a polygon scanner with a laser feed. The conjunction “and/or” is to be understood here and in the following in such a way that the features linked by this conjunction can be formed both jointly and as alternatives to one another. A laser feed is to be understood here in particular as a laser beam feed speed, i.e. the speed at which the first and/or second laser beam is moved over the cutting point. The polygon scanner suitably has a laser feed or a laser beam feed speed of from 2 m/s to 1000 m/s. As a result, the laser beams are moved particularly quickly over the cutting point, meaning the heat input, i.e. the thermal load on the electrode strip material, is particularly low.

The first and the second laser beam are preferably generated by a common laser. This means that the first and the second laser beam are, for example, two or more different laser pulses from the laser.

In a suitable embodiment, the first laser beam is guided over the cutting point several times in succession during the first method step. This means that there is repeated guidance of the laser beam over the cutting point during the first method step. For example, the first laser beam is moved over the cutting point between one and 100 times.

The repeated guidance is preferably carried out at the greatest possible speed, i.e. the greatest possible laser feed. This makes it possible to realize the kerf or cutting notch with a particularly low or moderate laser power, which reduces the heat input or the heat input zone in the region of the kerf or cutting notch. As a result, improved edge qualities of the kerf or cutting notch, and thus the battery electrode edge, can be realized.

In an expedient embodiment, the second laser beam is also guided over the cutting point several times in succession during the second method step. The second laser beam is preferably moved over the cutting point less frequently during the second method step than the first laser beam is in the first method step. This means that the number of times that the guidance is repeated in the second method step is smaller than in the first method step. For example, the second laser beam is moved over the cutting point between one and 20 times.

The repeated guidance is preferably also carried out with the greatest possible laser feed. As a result, the severing, i.e. the laser cut resulting in splitting, can be achieved with a low or moderate laser power, meaning the heat input or the heat input zone in the region of the cutting edge is reduced. This ensures a particularly high cutting edge quality of the separated battery electrodes.

In addition, a particularly narrow cutting gap, i.e. a cutting gap with a reduced clear width, can be realized due to the rapid repeated guidance, in particular during the first method step. This advantageously reduces the mechanical strain on the electrode strip material in the region of the cutting gap. In particular, this ensures that the electrode strip material or the cutting point does not sag in the region of the cutting gap as far as possible, as a result of which the electrode strip material is held in the plane of the focal point of the second laser beam. This means that the narrowest possible cutting gaps can be realized even for larger battery electrode dimensions, i.e. for larger widths of the electrode strip material.

The repeated guidance during the first and/or second method step allows cold ablation of the electrode strip material, i.e. ablation with a particularly small heat input zone.

Expediently, the ablated material of the electrode strip material is sucked off during the first and second method step, i.e. removed by means of an air or blowing stream. Only relatively little ablated material is generated in the course of the repeated guidance, which means that particularly simple and reliable suction can be achieved. In particular, a particularly high volume flow with a reduced flow diameter is thus made possible. This further improves the quality of the produced battery electrodes.

According to an additional or further aspect of the invention, the first method step and/or the second method step are carried out without interrupting the conveyance of the vacuum belt. This means that the first method step and/or the second method step are carried out during the conveyance of the electrode strip material. In other words, the battery electrodes are separated without slowing down or stopping the vacuum belt. The laser separation of the battery electrodes thus takes place “on-the-fly”, i.e. during continuous conveyance of the electrode strip material. The conveyance of the electrode strip material is in particular not interrupted or slowed down. As a result, acceleration forces on the electrode strip material are substantially completely avoided. Furthermore, a particularly uniform and time-reduced production flow is ensured during the production of the battery electrodes.

The device according to the invention is suitable and designed for producing battery electrodes. The device has a first planar vacuum belt and a second planar vacuum belt and a cutting gap arranged therebetween. The first vacuum belt is used to convey the electrode strip material in a conveying direction to the cutting gap, the second vacuum belt being provided for the conveyance and removal of the separated battery electrodes. The device also has at least one laser for generating a first and/or second laser beam for severing the cutting points, i.e. for laser separation. The vacuum belts and the laser are coupled to a controller (i.e. a control unit).

The controller is generally designed—in terms of programs and/or circuitry—to carry out the above-described method according to the invention. The controller is thus specifically designed to drive and/or control the laser in such a way that a first laser beam partially ablates the active material coating of a cutting point using a first laser beam before the cutting point reaches the cutting gap, and a second laser beam completely severs the cutting point when the cutting point is in the region of the cutting gap.

In a preferred embodiment, the controller is formed, at least in the core, by a microcontroller having a processor and a data memory in which the functionality for carrying out the method according to the invention is implemented in terms of a program in the form of operating software (firmware) such that the method—possibly in interaction with a device user—is automatically carried out when the operating software is executed in the microcontroller. In the context of the invention, the controller can, however, alternatively also be formed by a non-programmable electronic component, such as an application-specific integrated circuit (ASIC), in which the functionality for carrying out the method according to the invention is implemented using circuitry means.

The laser is designed, for example, as a pulsed or continuous wave (CW) fiber laser. The fiber laser has a wavelength suitable for the ablation of the electrode strip material, preferably a wavelength in the green or infrared range (IR), for example approximately 530 nm or 1000 nm (nanometers). For example, the laser has a laser power in the kilowatt range (kW).

In the following, information regarding the spatial directions is also given in particular in a coordinate system of the device. The abscissa axis (X-axis, X-direction) is oriented in the longitudinal direction of the vacuum belt (conveying direction) and the ordinate axis (Y-axis, Y-direction) is oriented in the oblique direction of the vacuum belt (transverse direction) and the applicate axis (Z-axis, Z-direction) is oriented perpendicularly to the plane of the vacuum belt.

The first and/or second laser beam are moved over the electrode strip material for the separation, for example by means of three scanners. For example, three galvo scanners (X, Y, Z), in particular in the case of small battery electrode formats (smaller than 100 mm), or two galvo scanners (X, Z) and a polygon scanner (Y) are provided. It is also conceivable, for example, for three galvo scanners (X, Y, Z) to be coupled to a polygon scanner (Y).

In an advantageous embodiment, the first laser beam and/or the second laser beam can be moved by means of at least one polygon scanner, the at least one polygon scanner being suitably arranged at an angle to the first vacuum belt. The polygon scanner is thus tilted at a defined angle to the first vacuum belt. The angle is coordinated with a continuous belt feed of the first vacuum belt, i.e. the feed or the speed of the web material on the vacuum belt. In particular, the angle is adjusted on the basis of the belt feed of the first vacuum belt and the laser feed of the polygon scanner.

This means that the laser beams would be guided obliquely or so as to be askew over the electrode strip material when the first vacuum belt is at a standstill. In cooperation with the belt feed, however, the laser beams are guided in a straight line along the cutting point. The belt feed and the laser feed are therefore coordinated.

If the or each laser beam is guided several times over the cutting point, the polygon scanner is suitably repositioned, in cycles, at a defined distance in the conveying direction with each guidance, such that the laser beams always hit the same kerf or cutting notch at the cutting point of the electrode strip material. A particularly high cutting edge quality of the battery electrodes can thus be realized.

In an expedient development, the cutting gap is oriented obliquely to the conveying direction of the first vacuum belt. The shape of the cutting gap is therefore preferably coordinated with the continuous belt feed of the first vacuum belt and the laser feed of the second laser beam. As a result, the width of the cutting gap is further reduced, allowing a particularly compact device to be realized.

In a conceivable embodiment, the first laser beam and/or the second laser beam can be moved by means of a number of sequentially connected polygon scanners. Each of the polygon scanners is preferably—as explained above—arranged so as to be inclined or tilted at a defined angle to the first vacuum belt. The laser beams are deflected onto the different polygon scanners, for example by means of a beam switch. The number of polygon scanners is adapted to a desired number of guidances over the cutting point, and therefore thermal drifts of the individual polygon scanners are reduced or completely avoided. This allows an increase in the cycle time and thus a particularly uniform production flow during the production of the battery electrodes.

In a preferred application, a battery electrode produced using the method described above is used in a vehicle battery. The method according to the invention ensures a uniform production flow during the production of the battery electrode, in which the mechanical and thermal strain on the electrode strip material is reduced. The battery electrode thus has a particularly high cutting edge quality, which is advantageously transferred to the quality and performance of the vehicle battery equipped therewith.

### BRIEF DESCRIPTION OF THE DRAWINGS

An embodiment of the invention is explained in more detail below with reference to the drawings, in which:

FIG. 1 is a plan view of a device for producing battery electrodes,

FIG. 2 is a plan view of a first method step in the production of the battery electrodes,

FIG. 3 is a plan view of a second method step in the production of the battery electrodes, and

FIG. 4 is a perspective view of a polygon scanning head for laser separation of the battery electrodes.

Corresponding parts and dimensions are always provided with the same reference signs in all figures.

### DETAILED DESCRIPTION OF THE INVENTION

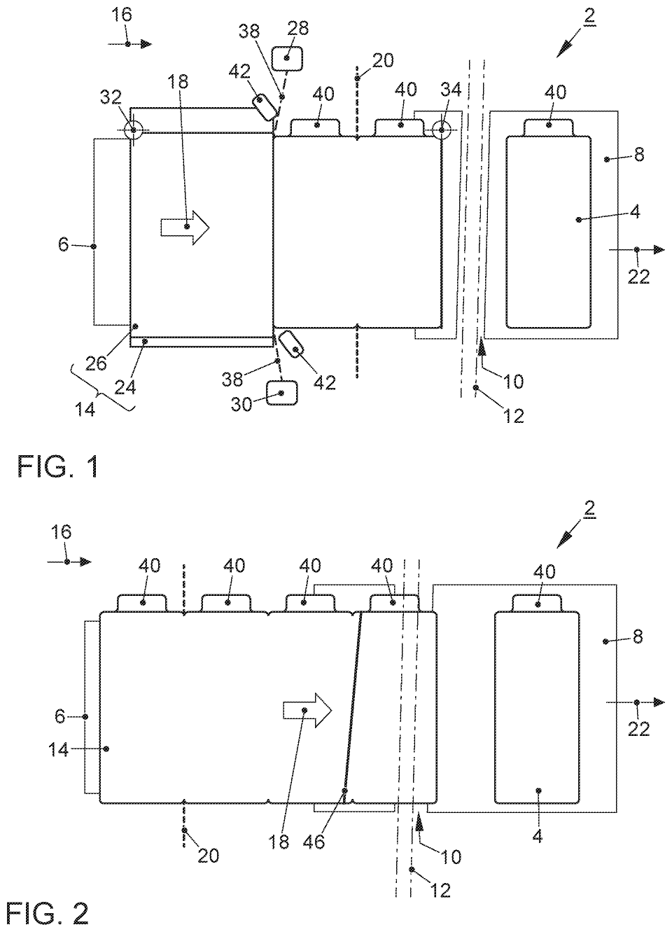

FIGS. 1 to 3 show a device 2 for producing battery electrodes 4 in simplified and schematic views. The battery electrodes 4 produced have an edge dimension of more than 100 mm, preferably between 300 and 600 mm, for example.

The device 2 has a first planar vacuum belt 6 and a second planar vacuum belt 8, which are spaced apart from one another by means of a recess 10. The recess 10 is arranged between the mutually facing end faces of the vacuum belts 6 and 8. In the region of the recess 10, a cutting gap 12 is provided which is shown by way of dot-dash lines in the figures.

By means of the vacuum belt 6, an electrode strip material 14 is conveyed to the cutting gap 12 in a conveying direction 16 with a continuous belt feed 18. The electrode strip material 14 is separated at predetermined cutting points 20 in the region of the cutting gap 12 to form the battery electrodes 4. The cutting points 20 are shown in the figures merely by way of example by means of dashed lines.

The battery electrodes 4 are transported by the vacuum belt 8 away from the cutting gap 12 in the conveying direction 16 with a continuous belt feed 22. The belt feeds 18 and 22 preferably have the same dimensions. The vacuum belts 6 and 8 each generate a negative pressure during operation, by means of which the electrode strip material 14 or the battery electrodes 4 are secured.

The strip-shaped or strip-like electrode strip material 14 is designed, for example, as a virtually endless roll material (electrode coil), and has an electrically conductive foil 24, for example a copper or aluminum foil, as a current conductor, and an active material coating 26 applied thereto.

The active material coating 26 is made from an electrode material, i.e. from an anode material or a cathode material. The electrode strip material 14 has, for example, a width of more than 100 mm, in particular between 300 and 600 mm, i.e. substantially the edge length of the battery electrodes 4, the length of the electrode strip material 14 being dimensioned so as to be substantially larger than its width or its height.

The device 2 has two laser optics or laser cutting elements 28, 30 for processing the electrode strip material 14, which are arranged to the side of the vacuum belt 6. The device 2 also has two optical sensor means 32, 34, for example in the form of cameras, which are arranged on the vacuum belt 6 so as to be spaced apart from one another in the conveying direction 18.

The sensor means 32 is arranged at the beginning of the vacuum belt 6, i.e spaced apart from the cutting gap 12, and the sensor means 34 is arranged at the end of the vacuum belt 6, i.e. in the region of the cutting gap 12. The sensor means 32 is provided in particular for web edge control, and is expediently arranged on the top and bottom of the vacuum belt 6. The sensor means 34 is provided in particular for detecting a transverse cut, by means of which the battery electrodes 4 are split or separated from the electrode strip material 14 along the cutting points 20.

A polygon scanning head 36 is provided for separating the battery electrodes 4, and is shown in detail in FIG. 4.

For example, the electrode strip material 14 has, in the longitudinal direction thereof, a non-coated or uncoated edge region of the foil 24, i.e. an edge-side foil region which is not provided with the active material coating 26. As can be seen relatively clearly in FIG. 1, the laser optics 28 and 30 each generate a laser beam 38 by means of which a conductor tab 40 for contacting the battery electrode 4 and rounded corner radii in the region of the cutting points 20 are cut from the edge region. The laser optics 28 cut an upper electrode region including the conductor tab 40 and radii, and the laser optics 30 cut a lower electrode region to a predetermined target length including radii. The material of the electrode strip material 14 which has been ablated in the course of laser cutting or laser processing is sucked off or removed through two suction devices 42 by means of an air or blowing stream.

The vacuum belts 6, 8 and the sensor means 32, 34 as well as the laser optics 30, 28 and the polygon scanning head 36 are connected by signals to a controller (not shown in more detail), i.e. to a control device or a control unit, and are controlled thereby.

The polygon scanning head 36 shown in detail in FIG. 4 has for example three lasers 44 in this embodiment. The lasers 44 each generate a laser beam 46, 46′ during operation, with only one active laser 44 being shown by way of example in FIG. 4. The lasers 44 are designed, for example, as pulsed fiber lasers and have a wavelength in the infrared range (IR), for example.

The laser beam 46, 46′ is directed to an associated polygon mirror as a polygon scanner 48, which reflects the laser beam 46, 46′ in the direction of the electrode strip material 14 or the cutting point 20. The polygon scanner 48 is rotated during operation such that the laser beam 46, 46′ is moved with a laser feed in an oblique or transverse direction, substantially perpendicularly to the conveying direction 16. The polygon scanners 48 have a laser feed of from 2 m/s to 1000 m/s, for example. As a result, the laser beams 46, 46′ are moved particularly quickly over the cutting points 20, meaning the heat input, i.e. the thermal load on the electrode strip material 14, is particularly low.

In one conceivable embodiment, the laser beams 46, 46′ of the lasers 44 are sequentially connected and guided over the cutting points 20 by means of the polygon scanner 48. This results in an increase in the cycle time and thus a particularly uniform production flow during the production of the battery electrodes 4.

The polygon scanners 48 are arranged so as to be inclined or tilted at an angle to the vacuum belt 6. The angles of inclination or tilt are adjusted to the continuous belt feed 18 of the vacuum belt 6 and the laser feed of the polygon scanner 48. This means that, in cooperation with the belt feed 18, the laser beams 46, 46′ are guided in a straight line along the cutting points 20.

Preferably, the or each laser beam 46, 46′ is guided, for the separation, several times over the relevant cutting point 20, the polygon scanning head 36 being suitably repositioned, in cycles, at a defined distance in the conveying direction 16 with each guidance, such that the laser beams 46, 46′ always hit the same kerf or cutting notch at the cutting point of the electrode strip material 14.

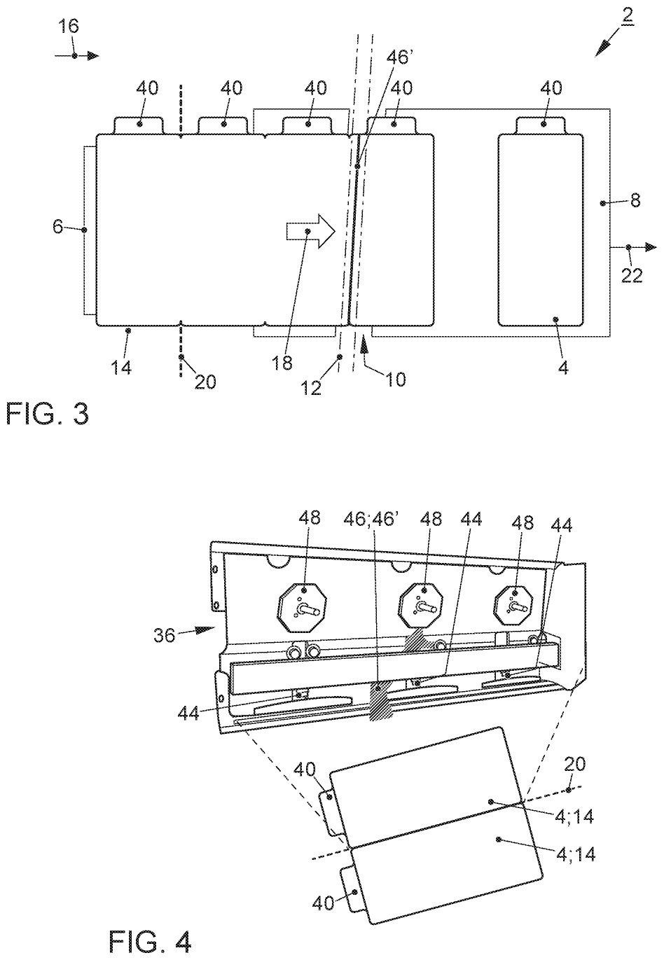

The method according to the invention for producing the battery electrodes 4 is explained in more detail below with reference to FIGS. 2 and 3.

FIG. 2 shows a first method step of the method, in which the active material coating 26 is partially ablated at a cutting point 20 using first laser beams 46 of the laser 44 of the polygon scanning head 36 before the cutting point 20 reaches the cutting gap 12. This means that the laser beams 46 create a kerf or cutting notch in the active material coating 26 in the region of the particular cutting point 20. Preferably, approximately 40% to 99% of the active material coating 26 is ablated. Since the electrode strip material 14 is not completely severed here, but is only partially ablated, no cutting gap is required for the laser ablation during the first method step.

The laser beams 46 are guided over the cutting point 20 several times in succession during the first method step. There is therefore repeated guidance of the laser beams 46 over the cutting point 20. In a suitable embodiment, the laser beams 46 are moved over the cutting point 20 between 1 and 100 times.

FIG. 3 shows a second method step following the first method step, in which the active material coating 26 and the foil 24 of the electrode strip material 14 are completely severed at the cutting point 20 using second laser beams 46′ when the cutting point 20 travels over the region of cutting gap 12. The cutting gap 12 is oriented obliquely to the conveying direction 16 of the vacuum belt 6, and is thus coordinated with the continuous belt feed 18 of the vacuum belt 6 and the laser feed of the second laser beams 46′.

The laser beams 46′ are guided over the cutting point 20 to be severed several times in succession during the second method step. The number of times that the guidance is repeated is preferably less than in the first method step. For example, the laser beams 46′ are moved over the cutting point 20 between 1 and 20 times.

The repeated guidance during the first and/or second method step allows cold ablation of the electrode strip material 14, i.e. ablation with a particularly small heat input zone. As a result, the severing, i.e. the laser cut resulting in splitting or severing, can be achieved with a low or moderate laser power, which ensures a particularly high cutting edge quality of the separated battery electrodes 4.

The repeated guidance takes place substantially without interrupting the conveyance of the vacuum belts 6, 8. In other words, the battery electrodes 4 are separated without the vacuum belts 6, 8 being slowed down or stopped. The laser separation of the battery electrodes 4 thus takes place “on-the-fly” during continuous conveyance of the electrode strip material 14.

The claimed invention is not limited to the embodiment described above. Rather, other variants of the invention can also be derived therefrom by a person skilled in the art within the scope of the disclosed claims without departing from the subject matter of the claimed invention. In particular, all of the individual features described in connection with the embodiment can also be combined in other ways within the scope of the disclosed claims without departing from the subject matter of the claimed invention.

### LIST OF REFERENCE SIGNS

2 device
4 battery electrode
6, 8 vacuum belt
10 recess
12 cutting gap
14 electrode strip material
16 conveying direction
18 belt feed
20 cutting point
22 belt feed
24 foil
26 active material coating
28, 30 laser optics
32, 34 sensor means
36 polygon scanning head
38 laser beam
40 conductor tabs
42 suction device
44 laser
46, 46′ laser beam
48 polygon scanner

1. A method for producing battery electrodes, comprising:
separating an electrode strip material comprising a foil and an active material coating applied thereto at predetermined cutting points (to form a number of battery electrodes,
conveying the battery electrodes on a planar vacuum belt in a conveying direction to a cutting gap,
partially ablating the active material coating of a cutting point using a first laser beam before the cutting point reaches the cutting gap, and
severing the active material coating and the foil of the cutting point using a second laser beam when the cutting point is in the region of the cutting gap.

2. The method according to claim 1, further comprising moving the first laser beam and/or the second laser beam along the cutting point by means of a polygon scanner.

3. The method according to either claim 1, further comprising guiding the first laser beam over the cutting point several times in succession during the partially ablating step.

4. The method according to claim 1, further comprising guiding the second laser beam over the cutting point several times in succession during the severing step.

5. The method according to claim 1, wherein the first method step and/or the second method step are carried out without interrupting the conveyance of the vacuum belt.

6. A device for producing battery electrodes, comprising
an electrode strip material comprising a foil and comprising an active material coating applied thereto and comprising a plurality of predetermined cutting points,
a first planar vacuum belt for conveying the electrode strip material in a conveying direction,
a second planar vacuum belt for conveying separated battery electrodes, separated from the first planar vacuum belt by a cutting gap,
at least one laser for generating a first and second laser beam for severing the cutting points, and
a controller for carrying out a method according to claim 1.

7. The device according to claim 6, wherein the first laser beam and/or the second laser beam can be moved by means of at least one polygon scanner, the at least one polygon scanner being arranged at an angle to the first vacuum belt.

8. The device according to claim 6, wherein the cutting gap extends obliquely to the conveying direction.

9. The device according to claim 6, wherein the first laser beam and/or the second laser beam can be moved by means of a number of sequentially connected polygon scanners.

10. A vehicle battery comprising a battery electrode which is produced using a method according to claim 1.
